(19) United States
(12) Patent Application Publication
(10) Pub. No.: US 2012/0253986 A1
(43) Pub. Date: Oct. 4, 2012

(54) DYNAMIC MULTI-LEVEL NETWORK MARKETING SYSTEM AND METHOD, AND COMPUTER-READABLE RECORDING MEDIUM

(76) Inventor: Chia-Chi Chang, New Taipei City (TW)

(21) Appl. No.: 13/157,296

(22) Filed: Jun. 9, 2011

(30) Foreign Application Priority Data
Mar. 30, 2011 (TW) 100111086

(51) Int. Cl. G06Q 30/00

(52) U.S. Cl. 705/27.1

(57) ABSTRACT

A dynamic multi-level network marketing system includes a communication network, a plurality of user terminal devices and a network trading platform system. The user terminal devices are in communication with the communication network. The network trading platform system is in communication with the user terminal devices through the communication network for providing online commodity sale and shopping service. The network trading platform system generates and stores a plurality of transaction and referral records according to a transaction of a specified product and a referral from the user terminal devices, so that a multi-level marketing relationship between the user terminal devices is dynamically established according to the transaction and referral records.

### FIELD OF THE INVENTION

The present invention relates to a multi-level network marketing system and a multi-level network marketing method, and more particularly to a dynamic multi-level network marketing system and a dynamic multi-level network marketing method. The present invention also relates to a computer-readable recording medium containing an application program for implementing the dynamic multi-level network marketing method.

### BACKGROUND OF THE INVENTION

A multi-level marketing system is a marketing strategy for directly selling products (e.g. goods or services) to consumers or potential members. The direct personal presentation, demonstration, and sale of products and services to consumers are usually performed in their homes, workplaces or other sites away from fixed retail locations. This marketing strategy has been utilized for many years and proved effective to directly sell products to the consumers. The sellers benefit from the multi-level marketing system because of personal demonstration and explanation of products.

In the multi-level marketing system, the direct sellers get the commissions based upon the volume of products sold through their own sales efforts and the sales volume of their downline organization. The multi-level marketing system provides opportunities of starting enterprises to the direct sellers. Moreover, the multi-level marketing system not only allows the direct sellers to sell products to the consumers but also encourage them to introduce and train their downline organization.

However, the conventional multi-level marketing system must make use of social relationships among its members to sell products. In other words, it is necessary to make a lot of face-to-face interactions to recommend the products and introduce others to join them as their immediate downline members. Moreover, it is also necessary to develop and train their downline organization to recommend and sell the products. The foregoing conditions may reduce their willingness to recommend the products or join as the members. Under this circumstance, the conventional multi-level marketing system fails to render rapid and vigorous growth of commodity trading and membership organization. Moreover, the membership affiliation of the conventional multi-level marketing system is decided on the basis of the referral and the order of joining as the member. In addition, the relationship between the upline member and the downline member is usually unchanged. Therefore, regardless of whether the upline member purchases products, the upline member can still earn the feedback cash from the consumption or sales practices of the downline members or the next-level downline members because of the relationship status. This will also reduce the willingness of their downline members to purchase products, recommended products and introduce others to join as the members.

Nowadays, with the advancement in information technology and the popularity of the Internet, the uses of e-commerce systems or online shopping systems for commodity trading have been widely accepted by general consumers. For facilitating product transactions between the buyers and the sellers, the current e-commerce systems or online shopping systems can only use coupons, discounts, bonuses or group-buying prices to implement the direct selling task. Due to lack of consumer willingness and support to participate in directly selling products, the multi-level marketing model is passive and the efficacy thereof is very limited. Therefore, the sellers' products fail to be quickly introduced to the potential buyers. In other words, the conventional multi-level marketing system fails to render rapid and vigorous growth of commodity trading and membership organization.

### SUMMARY OF THE INVENTION

The present invention provides a dynamic multi-level network marketing system and a dynamic multi-level network marketing method for dynamically implementing the dynamic multi-level network marketing efficacy through network connection. A multi-level marketing relationship is dynamically established according to the purchasing and referring behaviors of the buyers in order to calculate and distribute the feedback cash for the buyers. In such way, the willingness of the buyers to make a transaction and recommend the product will be enhanced and the sellers can quickly introduce their products to the potential customers. Therefore, the multi-level marketing system of the present invention is able to render rapid and vigorous growth of commodity trading and membership organization.

The present invention also provides a dynamic multi-level network marketing system and a dynamic multi-level network marketing method for dynamically establishing a multi-level marketing relationship between the buyers according to the occasional product transaction and referral behaviors. Moreover, the referred buyers can get the cash-back earning from the product referral after the online transaction behavior is done. Consequently, the willingness of the buyers to recommend the product to their friends or friends of a social network will be enhanced and the dynamic multi-level network marketing efficacy will be increased.

The present invention further provides a dynamic multi-level network marketing system and a dynamic multi-level network marketing method having an automatic sorting and a self-referral function, so that the willingness to make a transaction and recommend the product will be enhanced.

The present invention further provides a computer-readable recording medium containing an application program for implementing the dynamic multi-level network marketing method.

In accordance with an aspect of the present invention, there is provided a dynamic multi-level network marketing system. The dynamic multi-level network marketing system includes a communication network, a plurality of user terminal devices and a network trading platform system. The user terminal devices are in communication with the communication network. The network trading platform system is in communication with the user terminal devices through the communication network for providing online commodity sale and shopping service. The network trading platform system generates and stores a plurality of transaction and referral records according to a transaction of a specified product and a referral from the user terminal devices, so that a multi-level marketing relationship between the user terminal devices is dynamically established according to the transaction and referral records.

In accordance with another aspect of the present invention, there is provided a dynamic multi-level network marketing method. The dynamic multi-level network marketing method includes the following steps. Firstly, a communication network, a plurality of user terminal devices and a network trading platform system are provided. The user terminal devices are in communication with the communication network. The network trading platform system in communication with the user terminal devices through the communication network for providing online commodity sale and shopping service. Then, a plurality of transaction and referral records are generated and stored according to a transaction of a specified product and a referral from the user terminal devices, so that a multi-level marketing relationship between the user terminal devices is dynamically established according to the transaction and referral records.

In accordance with a further aspect of the present invention, there is provided a computer-readable recording medium containing an application program for implementing the dynamic multi-level network marketing method. The dynamic multi-level network marketing method includes steps of generating and storing a plurality of transaction and referral records according to a transaction of a specified product and a referral from a plurality of user terminal devices, and dynamically establishing a multi-level marketing relationship between the user terminal devices according to the transaction and referral records.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is schematically illustrates the architecture of a dynamic multi-level network marketing system according to an embodiment of the present invention;

FIG. 2 is a flowchart illustrating a dynamic multi-level network marketing method according to an embodiment of the present invention;

FIG. 3 schematically illustrates the contents of an exemplary web page of the network trading platform system according to the present invention;

FIG. 4 is a flowchart illustrating a dynamic multi-level network marketing method according to another embodiment of the present invention;

FIG. 5 schematically illustrates the contents of another exemplary web page of the network trading platform system according to the present invention;

FIG. 6 is a flowchart illustrating a variant example of the dynamic multi-level network marketing method of FIG. 4;

FIG. 7 is a flowchart illustrating a dynamic multi-level network marketing method according to another embodiment of the present invention;

FIG. 8 is a flowchart illustrating a dynamic multi-level network marketing method according to another embodiment of the present invention; and

FIG. 9 is a flowchart illustrating a self-referral procedure of a dynamic multi-level network marketing method according to another embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

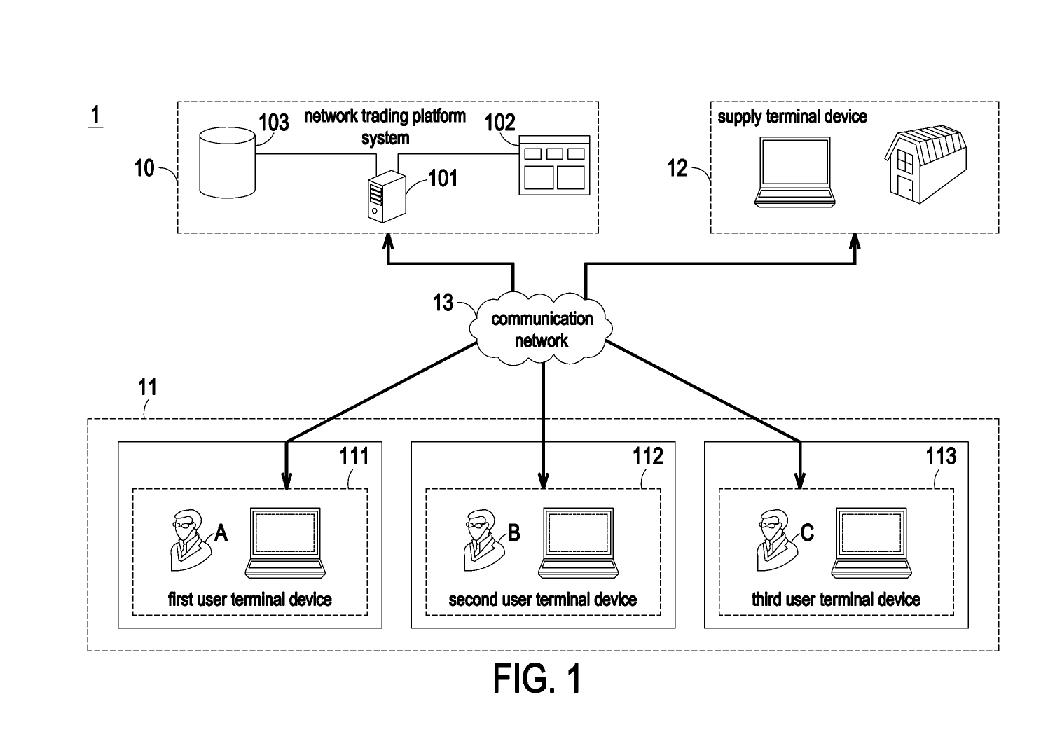

FIG. 1 is schematically illustrates the architecture of a dynamic multi-level network marketing system according to an embodiment of the present invention. As shown in FIG. 1, the dynamic multi-level network marketing system 1 comprises a network trading platform system 10, a plurality of user terminal devices 11, one or more supply terminal devices 12 and a communication network 13. The network trading platform system 10, the user terminal devices 11 and the supply terminal devices 12 are in communication with the communication network 13. Via the communication network 13, the bidirectional communication between the network trading platform system 10 and the user terminal devices 11 and the bidirectional communication between the network trading platform system 10 and the supply terminal devices 12 can be achieved. In this embodiment, the network trading platform system 10 comprises one or more servers 101. The user terminal devices 11 include but are not limited to computers, tablet personal computers or smart phones. The network trading platform system 10 is configured to provide online commodity sale and shopping service. The user terminal device 11 is operated by a specified user (also referred as a buyer or a consumer). The supply terminal device 12 is operated by a specified commodity supplier (also referred as a merchant).

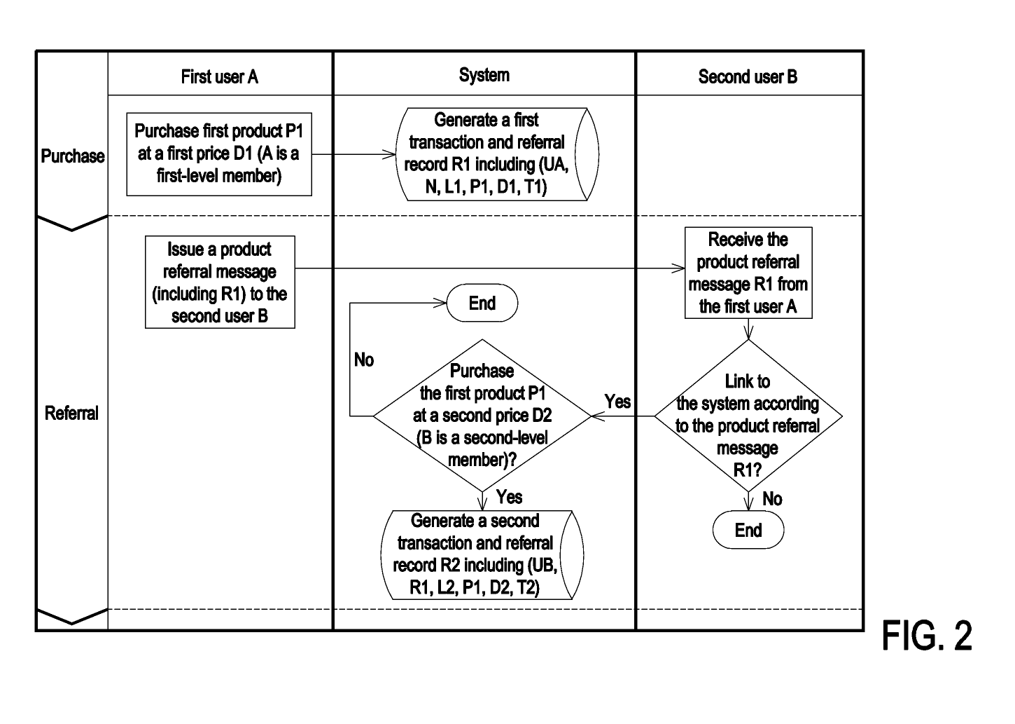

FIG. 2 is a flowchart illustrating a dynamic multi-level network marketing method according to an embodiment of the present invention. Please refer to FIGS. 1 and 2. Through the user terminal device 11, the user may issues a registration request to the network trading platform system 10. In response to the registration request, the network trading platform system 10 provides a user account to the user. By inputting the user account, the user may be registered to be a member and access the network trading platform system 10 to use the network marketing service. After the user accesses the network trading platform system 10 through a portal site 102 of the network trading platform system 10, the user may browse the commodities (including an actual product, a service or a digital content data) listed in the network trading platform system 10 and determine whether a transaction is done. For example, through the user terminal device 11, the user may issue a transaction confirmation signal to the network trading platform system 10 to confirm that the user wants to purchase a specified product P at a specified price D. In response to the transaction confirmation signal, the network trading platform system 10 automatically generates a transaction and referral record R and stores the transaction and referral record R in a database 103 of the network trading platform system 10. In an embodiment, the transaction and referral record R at least comprises a user identification code U, a referral record source code, a level code L, a product identification code P, a product price D and a transaction time T.

In this embodiment, the user terminal devices 11 comprises a first user terminal device 111 and a second user terminal device 112, which are respectively operated by a first user A and a second user B. The network trading platform system 10 is in communication with the first user terminal device 111 of the first user A and the second user terminal device 112 of the second user B. Through the first user terminal device 111, the first user A issues a registration request to the network trading platform system 10. In response to the registration request, the network trading platform system 10 provides a user account UA to the first user A. By inputting the user account UA, the first user A may be registered to be a member and access the network trading platform system 10 to use the network marketing service. After the first user A accesses the network trading platform system 10 through a portal site 102 of the network trading platform system 10, the first user A may browse the commodities listed in the network trading platform system 10 and determine whether a transaction is done. Through the first user terminal device 111, the first user A may issue a transaction confirmation signal to the network trading platform system 10 to confirm that the first user A wants to purchase a first product P1 at a first price D1. In response to the transaction confirmation signal, the network trading platform system 10 automatically generates a first transaction and referral record R1 and stores the first transaction and referral record R1 in the database 103 of the network trading platform system 10. In this embodiment, the first transaction and referral record R1 at least comprises a user identification code UA, a referral record source code “N”, a level code L1, a product identification code P1, a product price D1 and a transaction time T1. The user identification code UA denotes that this transaction is implemented by the first user A. The referral record source code “N” denotes that this transaction is originally created without following any referral record source. The level code L1 denotes that the first user A is the first-level member of the dynamic multi-level network marketing structure. The product identification code P1 denotes that the product to be purchased is the first product P1. The product price D1 denotes that the product price is the first price D1. The transaction time T1 denotes that the transaction is made at the time T1.

After the transaction of the first user A has been done, the network trading platform system 10 actively issues a web page notification message to the first user terminal device 111. The web page notification message may notify the first user A of the completion of the transaction and prompt the first user A whether a referral of the first product P1 needs to be issued. The web page notification message includes the message associated with the cash-back earning from the product referral.

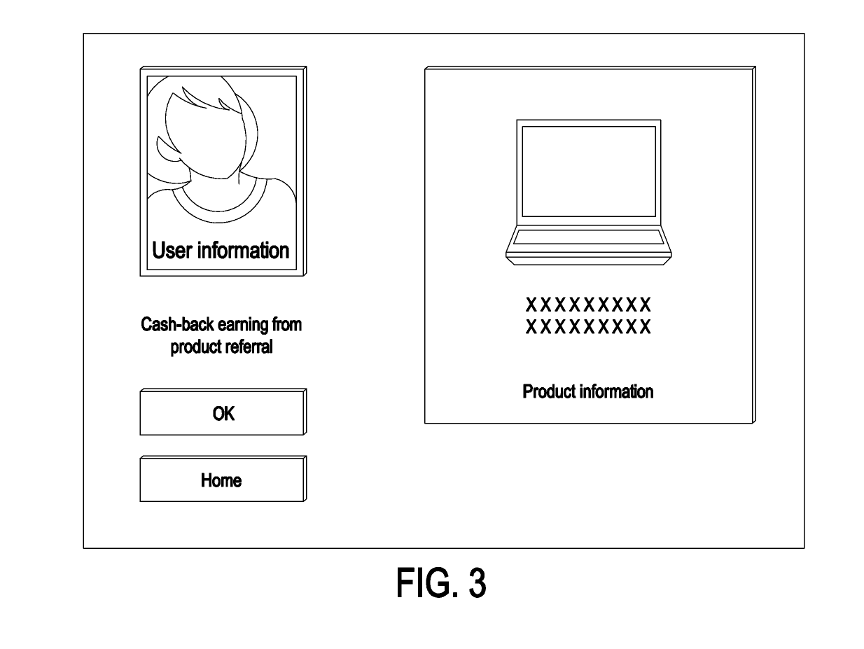

Please refer to FIG. 3, which illustrates the contents of an exemplary web page of the network trading platform system according to the present invention. When the first user A wants to issue a product referral message to his (or her) friends or familiar or unfamiliar friends of a social network according to the web page notification message or a fancy to the traded product, the first user A may confirm the web page notification message and select the address data of the to-be-referred persons. The to-be-referred persons may be the registered members or non-members. After a referral confirmation signal from the first user terminal device 111 is received by the network trading platform system 10, the network trading platform system 10 automatically issues a product referral message to the person(s) referred by the first user A. For example, the referred person is the second user B. In an embodiment, the network trading platform system 10 may actively issues a first product referral message to the e-mail box of the second user B. For example, the first product referral message is a web page link message including the first transaction and referral record R1.

After the first product referral message from the first user A or the network trading platform system 10 is received by the second user terminal device 112 of the second user B, the second user B may link to the network trading platform system 10 according to the first product referral message. The second user B may issue a transaction confirmation signal to the network trading platform system 10 to confirm that the second user B wants to purchase the first product P1 at a second price D2, wherein the second price D2 and the first price D1 are identical or different. In response to the transaction confirmation signal, the network trading platform system 10 automatically generates a second transaction and referral record R2 and stores the second transaction and referral record R2 in the database 103 of the network trading platform system 10. In an embodiment, the second transaction and referral record R2 at least comprises a user identification code UB, a referral record source code “R1”, a level code L2, a product identification code P1, a product price D2 and a transaction time T2. The user identification code UB denotes that this transaction is implemented by the second user B. The referral record source code “R1” denotes that this transaction is implemented by following the first product referral message of the first user A. The level code L2 denotes that the second user B is the second-level member of the dynamic multi-level network marketing structure. The product identification code P1 denotes that the product to be purchased is the first product P1. The product price D2 denotes that the product price is the second price D2. The transaction time T2 denotes that the transaction is made at the time T2.

On the other hand, after the first product referral message from the first user A or the network trading platform system 10 is received by the second user terminal device 112 of the second user B, if the user B does not link to the network trading platform system 10 according to the first product referral message, the network trading platform system 10 will not generate any transaction and referral record associated with the second user B.

In this embodiment, the second user B is a registered member or a non-member. If the second user B is a non-member who wants to purchase a specified product by following the first product referral message of the first user A, the network trading platform system 10 issues a registration and access message to guide the second user B to be registered as a member. In such way, the number of members of the dynamic multi-level network marketing system will be increased. Of course, the second user B may actively provide a similar product referral message to other persons to achieve the dynamic multi-level network marketing structure.

The network trading platform system 10 not only implements the above network trading and active referring procedures but also automatically implements a cash-back operation. The cash-back operation automatically implemented by the network trading platform system 10 will be illustrated as follows. Firstly, the network trading platform system 10 periodically searches the data stored in the database 103. That is, the network trading platform system 10 may search the transaction and referral records in a constant time cycle. For example, according to the transaction and referral records, the first user A and the second user B are respectively assigned as a first-level member and a second-level member by the network trading platform system 10. By the network trading platform system 10, the referral recode codes including the referral record source code “R1” and the level code “L2” are searched from the plurality of transaction and referral records, and the product price D is acquired. Then, the network trading platform system 10 will multiply the product price D and a first predetermined feedback cash percentage W1 % of the first-level member together. In such way, the feedback cash based on the product transaction and referral behavior of the first user A is obtained. That is, the feedback cash for the first user A=(D2)×W1 %, wherein W1 is a positive number. Similarly, the network trading platform system 10 will multiply the product price D and a second predetermined feedback cash percentage W2 % of the second-level member together. In such way, the feedback cash based on the product transaction and referral behavior of the second user B is obtained. That is, the feedback cash for the second user B=(D2)×W2 %, wherein W2 is a positive number.

From the above description, the dynamic multi-level network marketing method of the present invention is implemented by the network trading platform system 10. The multi-level marketing relationship between the first user A and the second user B is established according to the transaction completion message of a specified product and a referral message. In comparison with the unchanged relationship between the upline member and the downline member according to the prior art, the multi-level marketing relationship is dynamically established according to the present invention. That is, the multi-level marketing relationship between the first user A and the second user B may be changed according to the transaction completion message of another product and a referral message. In the multi-level marketing relationship of the dynamic multi-level network marketing system of the present invention, every user has the transaction record of the specified product. Whenever the specified product is purchased by any user, the dynamic multi-level network marketing system will automatically provide a referral right. According to the unique transaction and referral record generated by the dynamic multi-level network marketing system, the user may realize the possible feedback cash.

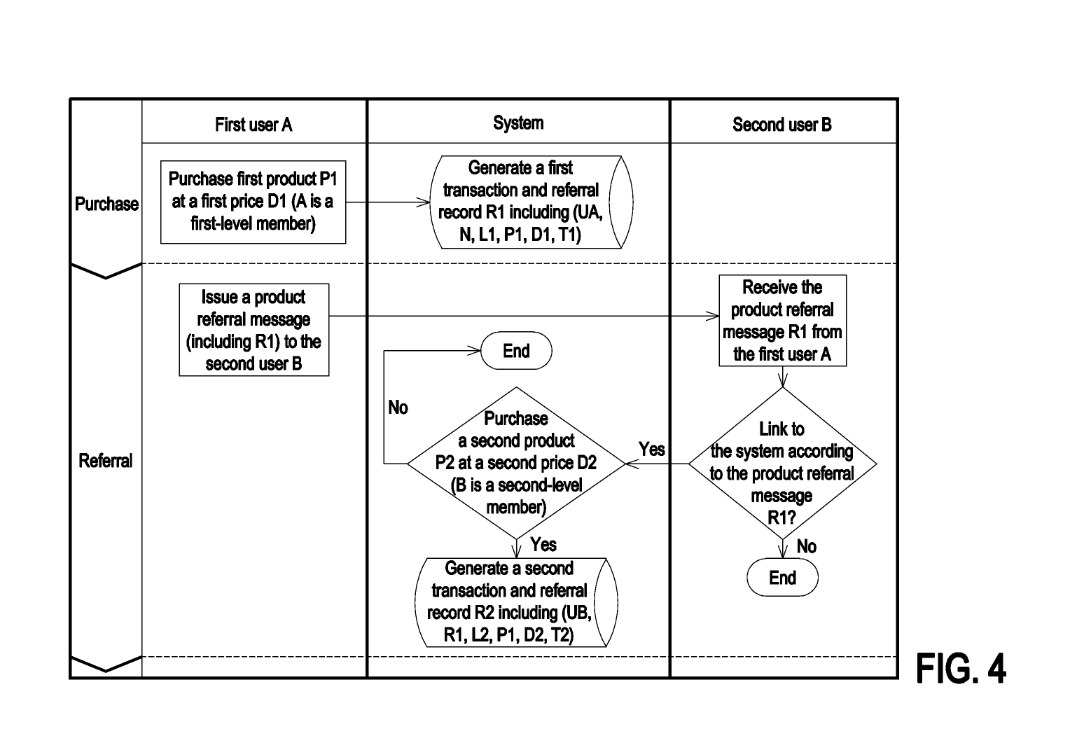

FIG. 4 is a flowchart illustrating a dynamic multi-level network marketing method according to another embodiment of the present invention. Please refer to FIGS. 1 and 4. After the first user A accesses the network trading platform system 10 through the portal site 102 of the network trading platform system 10, the user may browse the commodities listed in the network trading platform system 10 and determine whether a transaction is done. Through the first user terminal device 111, the first user A may issue a transaction confirmation signal to the network trading platform system 10 to confirm that the user wants to purchase a first product P1 at a first price D1. In response to the transaction confirmation signal, the network trading platform system 10 automatically generates a first transaction and referral record R1 and stores the first transaction and referral record R1 in the database 103 of the network trading platform system 10. After the transaction of the first user A has been done, the network trading platform system 10 actively issues a web page notification message to the first user terminal device 111. The web page notification message may notify the first user A of the completion of the transaction and prompt the first user A whether a referral of the first product P1 needs to be issued. The web page notification message may include the message associated with the cash-back earning from the product referral. When the first user A wants to issue a product referral message to his (or her) friends or familiar or unfamiliar friends of a social network according to the web page notification message or a fancy to the traded product, the first user A may confirm the web page notification message and select the address data of the to-be-referred persons. The to-be-referred persons may be the registered members or non-members. After a referral confirmation signal from the first user terminal device 111 is received by the network trading platform system 10, the network trading platform system 10 automatically issues a product referral message to the person(s) referred by the first user A. For example, the referred person is the second user B. In an embodiment, the network trading platform system 10 may actively issues a first product referral message to the e-mail box of the second user B. For example, the first product referral message is a web page link message including the first transaction and referral record R1. In an embodiment, the first transaction and referral record R1 at least comprises a user identification code UA, a referral record source code “N”, a level code L1, a product identification code P1, a product price D1 and a transaction time T1.

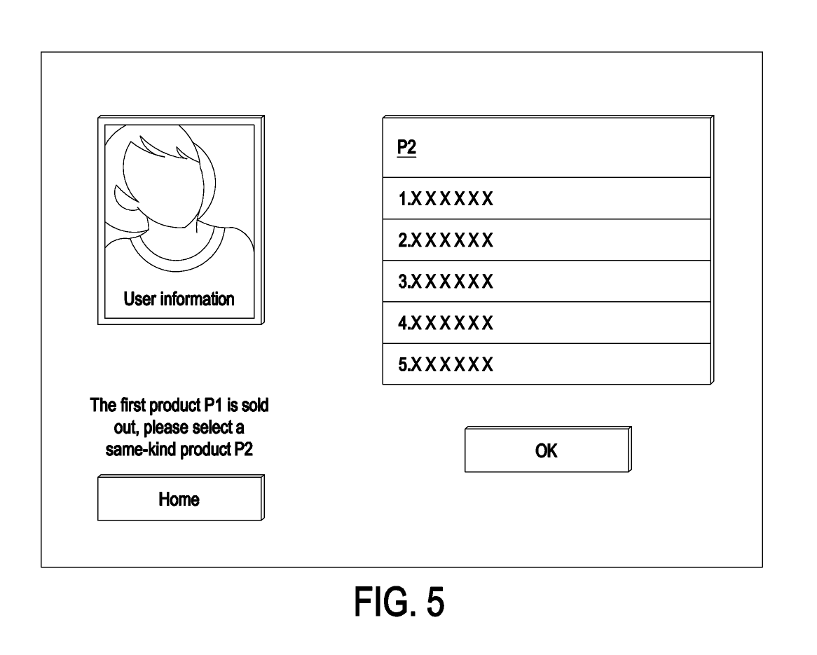

After the first product referral message from the first user A or the network trading platform system 10 is received by the second user terminal device 112 of the second user B, the second user B may link to the network trading platform system 10 according to the first product referral message. If the first product P1 is sold out or out of stock, associated message may be included in the contents of the web page link message by the network trading platform system 10. Please refer to FIG. 5, which illustrates the contents of another exemplary web page of the network trading platform system according to the present invention. As shown in FIG. 5, the contents of the web page includes the message indicating that the first product P1 is sold out or out of stock and the message recommending the second user B to purchase a same-kind product P2. For example, the first product P1 and the second product P2 are like products with different specifications or colors. Alternatively, the first product P1 and the second product P2 are similar products. Under this circumstance, the second user B may made a transaction according to the first product referral message provided by the first user A or the same-kind product referral message provided by the network trading platform system 10. The second user B may issue a transaction confirmation signal to the network trading platform system 10 to confirm that the second user B wants to purchase the first product P1 at a second price D2. In response to the transaction confirmation signal, the network trading platform system 10 automatically generates a second transaction and referral record R2 and stores the second transaction and referral record R2 in the database 103 of the network trading platform system 10. In an embodiment, the second transaction and referral record R2 at least comprises a user identification code UB, a referral record source code “R1”, a level code L2, a product identification code P1, a product price D2 and a transaction time T2.

On the other hand, after the first product referral message from the first user A or the same-kind product referral message from the network trading platform system 10 is received by the second user terminal device 112 of the second user B, if the user B does not link to the network trading platform system 10 according to the first product referral message or the same-kind product referral message, the network trading platform system 10 will not generate any transaction and referral record associated with the second user B.

Since the network trading platform system 10 is able to sort the product in advance, after the second user B links to the network trading platform system 10 according to the first product referral message from the first user A, the second user B may choose the similar product or the same-kind product. That is, regardless of whether the first product P1 or the same-kind product P2 is purchased by the second user B, the cash-back operation is also implemented. In such way, the willingness to make a transaction and recommend the product will be enhanced. The subsequent cash-back operation implemented by the network trading platform system 10 is similar to that of FIG. 2, and is not redundantly described herein.

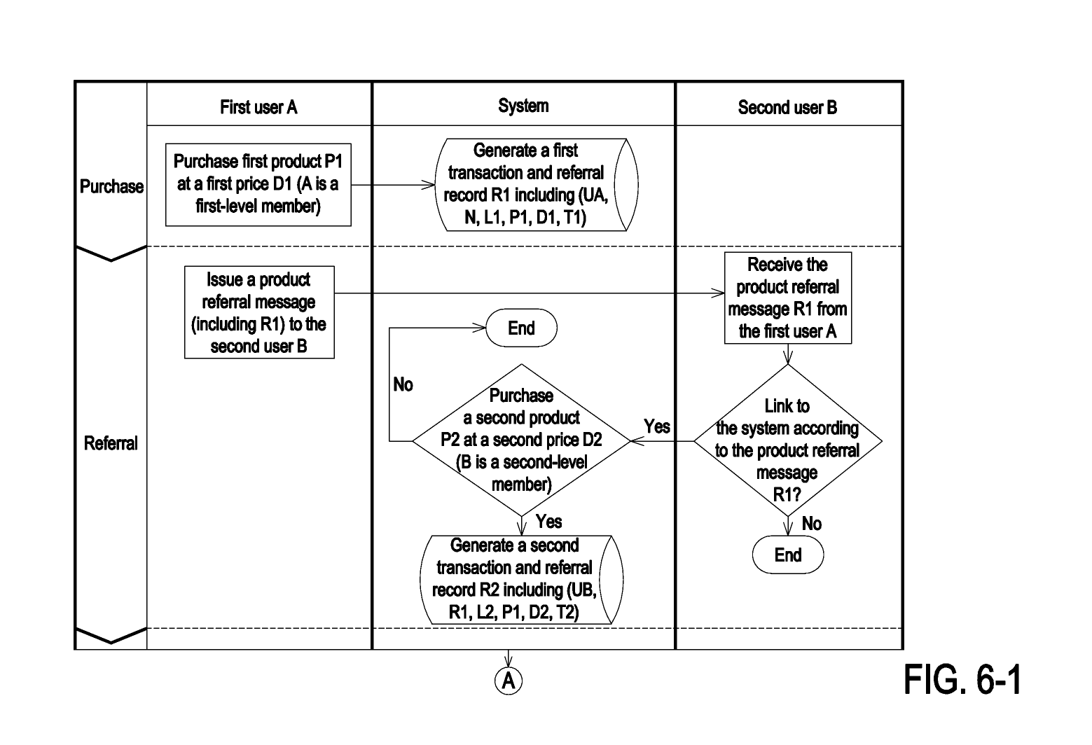

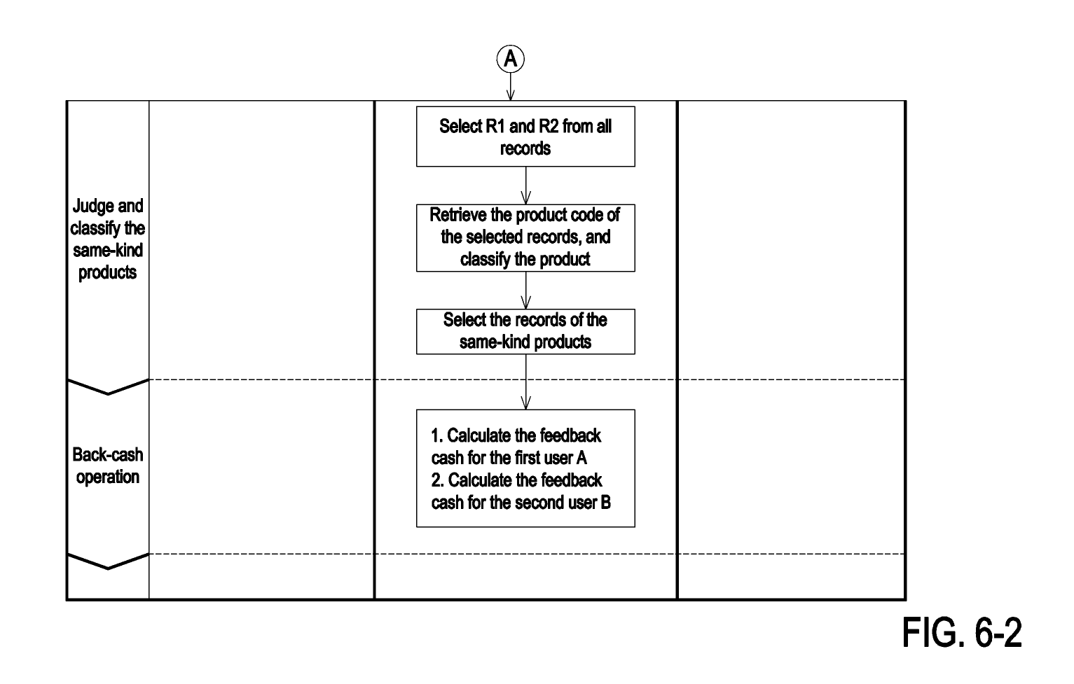

It is noted that numerous modifications and alterations of the connection member may be made while retaining the teachings of the invention. For example, the product is not sorted by the network trading platform system 10 in advance. However, in the subsequent cash-back operation, a step of judging whether the second product P2 and the first product P1 are the same-kind products will be performed. FIG. 6 is a flowchart illustrating a variant example of the dynamic multi-level network marketing method of FIG. 4. The purchasing and referring actions of the first user A, the second user B and the network trading platform system 10 included in this embodiment are similar to those of FIG. 4, and are not redundantly described herein. However, prior to the subsequent cash-back operation, a sorting procedure is performed. Firstly, by the network trading platform system 10, the referral recode codes including the referral record source code “R1” and the level code “L2” are searched from the plurality of transaction and referral records, and the product identification code P (e.g. the second product P2) is acquired. Then, according to the default settings, the network trading platform system 10 judges whether the second product P2 and the referred first product P1 are the same-kind products. If the judging condition is satisfied, the transaction of the second product P2 is included in the cash-back operation for the first user A. Whereas, if the judging condition is not satisfied, the transaction of the second product P2 is not included in the cash-back operation for the first user A. The subsequent cash-back operation implemented by the network trading platform system 10 is similar to that of FIG. 2, and is not redundantly described herein.

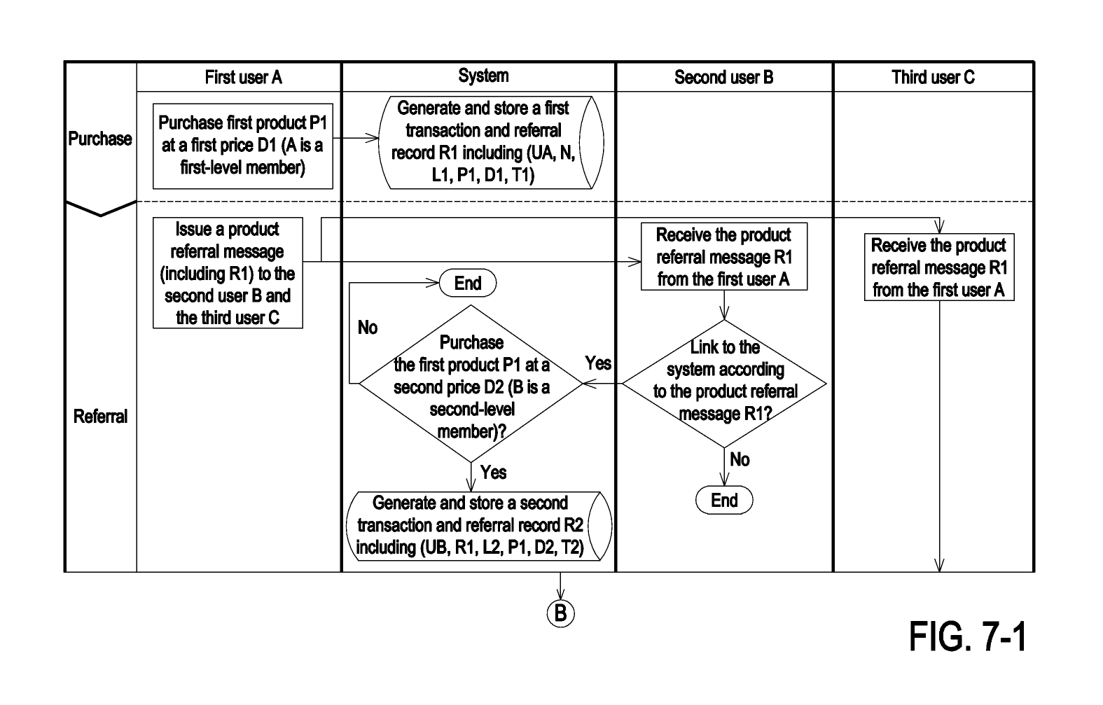

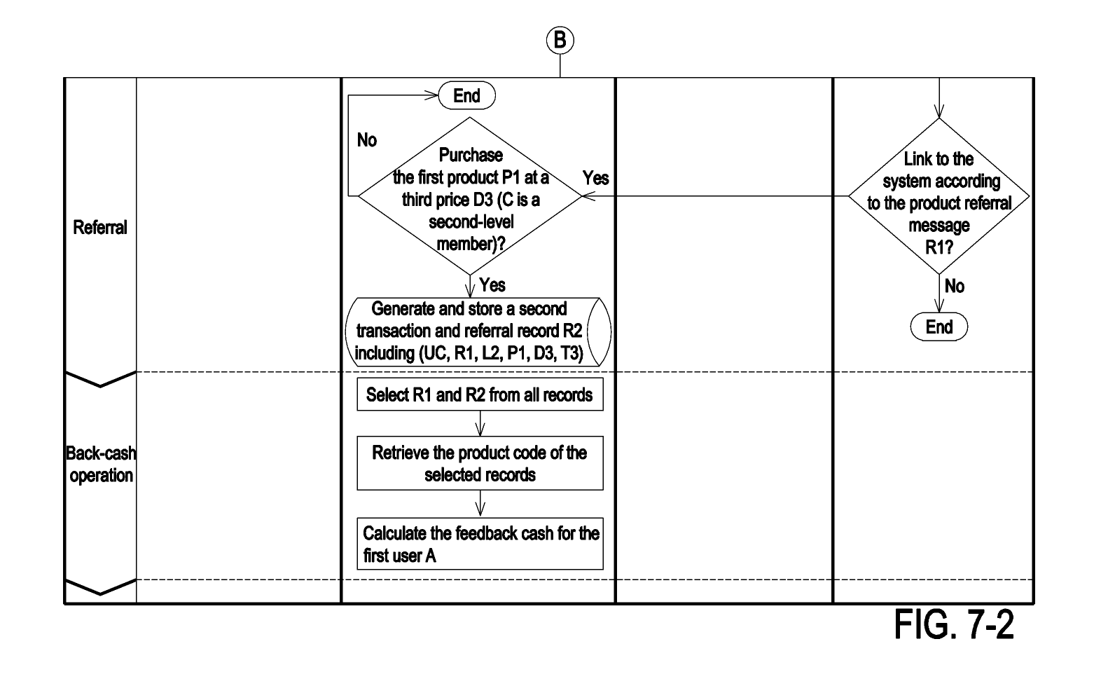

FIG. 7 is a flowchart illustrating a dynamic multi-level network marketing method according to another embodiment of the present invention. Please refer to FIGS. 1 and 7. In an embodiment, the user terminal devices 11 comprises a first user terminal device 111, a second user terminal device 112 and a third user terminal device 113, which are respectively operated by a first user A, a second user B and a third user C. The network trading platform system 10 is in communication with the first user terminal device 111 of the first user A, the second user terminal device 112 of the second user B and the third user terminal device 113 of the third user C. After the first user A accesses the network trading platform system 10 through the portal site 102 of the network trading platform system 10, the first user A may browse the commodities listed in the network trading platform system 10 and determine whether a transaction is done. Through the first user terminal device 111, the first user A may issue a transaction confirmation signal to the network trading platform system 10 to confirm that the first user A wants to purchase a first product P1 at a first price D1. In response to the transaction confirmation signal, the network trading platform system 10 automatically generates a first transaction and referral record R1 and stores the first transaction and referral record R1 in the database 103 of the network trading platform system 10. In an embodiment, the first transaction and referral record R1 at least comprises a user identification code UA, a referral record source code “N”, a level code L1, a product identification code P1, a product price D1 and a transaction time T1. The user identification code UA denotes that this transaction is implemented by the first user A. The referral record source code “N” denotes that this transaction is originally created without following any referral record source. The level code L1 denotes that the first user A is the first-level member of the dynamic multi-level network marketing structure. The product identification code P1 denotes that the product to be purchased is the first product P1. The product price D1 denotes that the product price is the first price D1. The transaction time T1 denotes that the transaction is made at the time T1.

After the transaction of the first user A has been done, the network trading platform system 10 actively issues a web page notification message to the first user terminal device 111. The web page notification message may notify the first user A of the completion of the transaction and prompt the first user A whether a referral of the first product P1 needs to be issued. The web page notification message includes the message associated with the cash-back earning from the product referral. When the first user A wants to issue a product referral message to his (or her) friends or familiar or unfamiliar friends of a social network according to the web page notification message or a fancy to the traded product, the first user A may confirm the web page notification message and select the address data of the to-be-referred persons. The to-be-referred persons may be the registered members or non-members. After a referral confirmation signal from the first user terminal device 111 is received by the network trading platform system 10, the network trading platform system 10 automatically issues a product referral message to the person(s) referred by the first user A. For example, the network trading platform system 10 automatically issues the product referral message to the second user B and the third user C simultaneously. In an embodiment, the network trading platform system 10 may actively issues a first product referral message to the e-mail boxes of the second user B and the third user C. For example, the first product referral message is a web page link message including the first transaction and referral record R1.

After the first product referral message from the first user A or the network trading platform system 10 is received by the second user terminal device 112 of the second user B, the second user B may link to the network trading platform system 10 according to the first product referral message. The second user B may issue a transaction confirmation signal to the network trading platform system 10 to confirm that the second user B wants to purchase the first product P1 at a second price D2, wherein the second price D2 and the first price D1 are identical or different. In response to the transaction confirmation signal, the network trading platform system 10 automatically generates a second transaction and referral record R2 and stores the second transaction and referral record R2 in the database 103 of the network trading platform system 10. In an embodiment, the second transaction and referral record R2 at least comprises a user identification code UB, a referral record source code “R1”, a level code L2, a product identification code P1, a product price D2 and a transaction time T2. On the other hand, after the first product referral message from the first user A or the network trading platform system 10 is received by the second user terminal device 112 of the second user B, if the second user B does not link to the network trading platform system 10 according to the first product referral message, the network trading platform system 10 will not generate any transaction and referral record associated with the second user B.

After the first product referral message from the first user A or the network trading platform system 10 is received by the third user terminal device 113 of the third user C, the third user C may link to the network trading platform system 10 according to the first product referral message. The third user C may issue a transaction confirmation signal to the network trading platform system 10 to confirm that the third user C wants to purchase the first product P1 at a third price D3, wherein the first price D1, the second price D2 and the third price D3 are identical or different. In response to the transaction confirmation signal, the network trading platform system 10 automatically generates a third transaction and referral record R3 and stores the third transaction and referral record R3 in the database 103 of the network trading platform system 10. In an embodiment, the third transaction and referral record R3 at least comprises a user identification code UC, a referral record source code “R1”, a level code L2, a product identification code P1, a product price D3 and a transaction time T3. On the other hand, after the first product referral message from the first user A or the network trading platform system 10 is received by the third user terminal device 113 of the third user C, if the third user C does not link to the network trading platform system 10 according to the first product referral message, the network trading platform system 10 will not generate any transaction and referral record associated with the third user C.

In this embodiment, the second user B and the third user C are registered members or non-members. If the second user B and the third user C are non-member who wants to purchase a specified product by following the first product referral message of the first user A, the network trading platform system 10 issues a registration and access message to guide the second user B and the third user C to be registered as members. In such way, the number of members of the dynamic multi-level network marketing system will be increased. Of course, the second user B or the third user C may actively provide a same-kind product referral message to other persons to achieve the dynamic multi-level network marketing structure.

The network trading platform system 10 not only implements the above network trading and active referring procedures but also automatically implements a cash-back operation. The cash-back operation automatically implemented by the network trading platform system 10 will be illustrated as follows. Firstly, the network trading platform system 10 periodically searches the data stored in the database 103. That is, the network trading platform system 10 may search the transaction and referral records in a constant time cycle. For example, according to the transaction and referral records, the first user A, the second user B and the third user C are respectively assigned as a first-level member, a second-level member and a second-level member by the network trading platform system 10. By the network trading platform system 10, the referral recode codes including the referral record source code “R1” and the level code “L2” are searched from the plurality of transaction and referral records, and the product price D is acquired. Then, the network trading platform system 10 will multiply the product price D and a first predetermined feedback cash percentage W1 % of the first-level member together. In such way, the feedback cash based on the product transaction and referral behavior of the first user A is obtained. That is, the feedback cash for the first user A=(D2+D3)×W1 %, wherein W1 is a positive number. Similarly, the network trading platform system 10 will multiply the product price D and a second predetermined feedback cash percentage W2 % of the second-level member together. In such way, the feedback cash based on the product transaction and referral behavior of the second user B is obtained. That is, the feedback cash for the second user B=(D2)×W2 %, wherein W2 is a positive number. Similarly, the network trading platform system 10 will multiply the product price D and the second predetermined feedback cash percentage W2 % of the second-level member together. In such way, the feedback cash based on the product transaction and referral behavior of the third user C is obtained. That is, the feedback cash for the third user C=(D3)×W2 %, wherein W2 is a positive number.

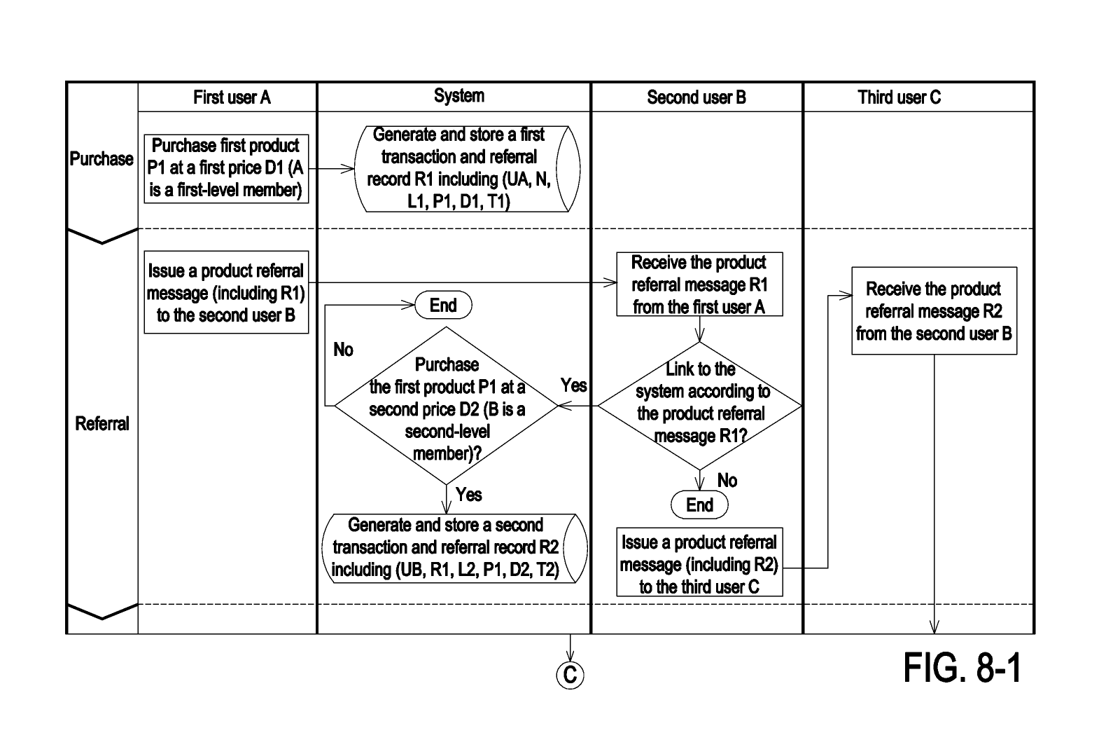

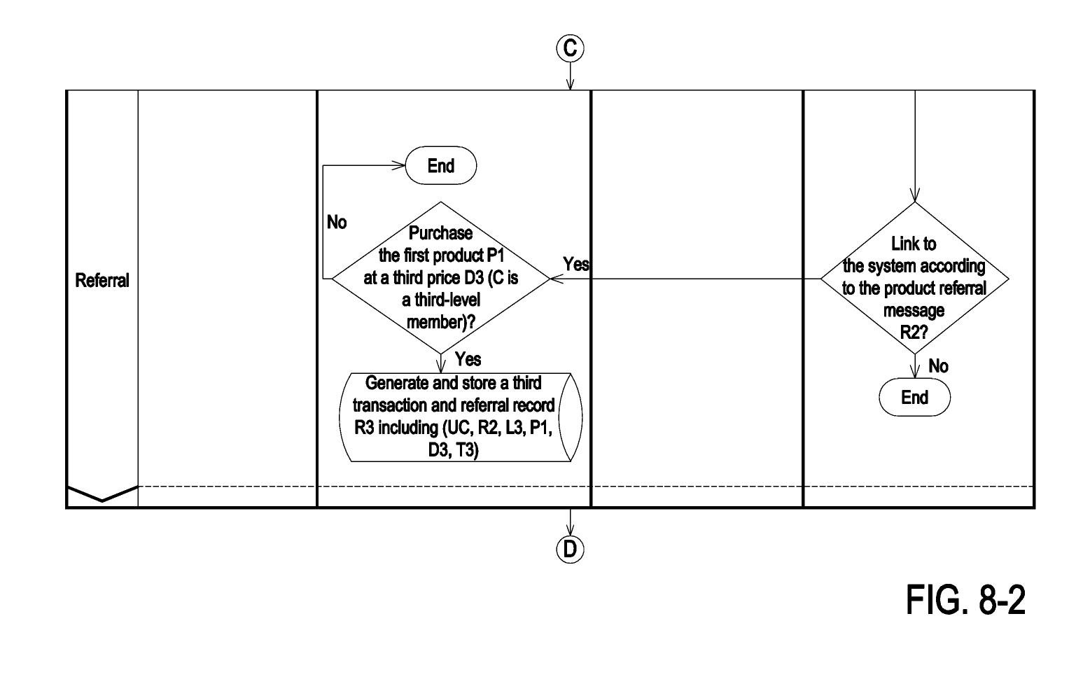

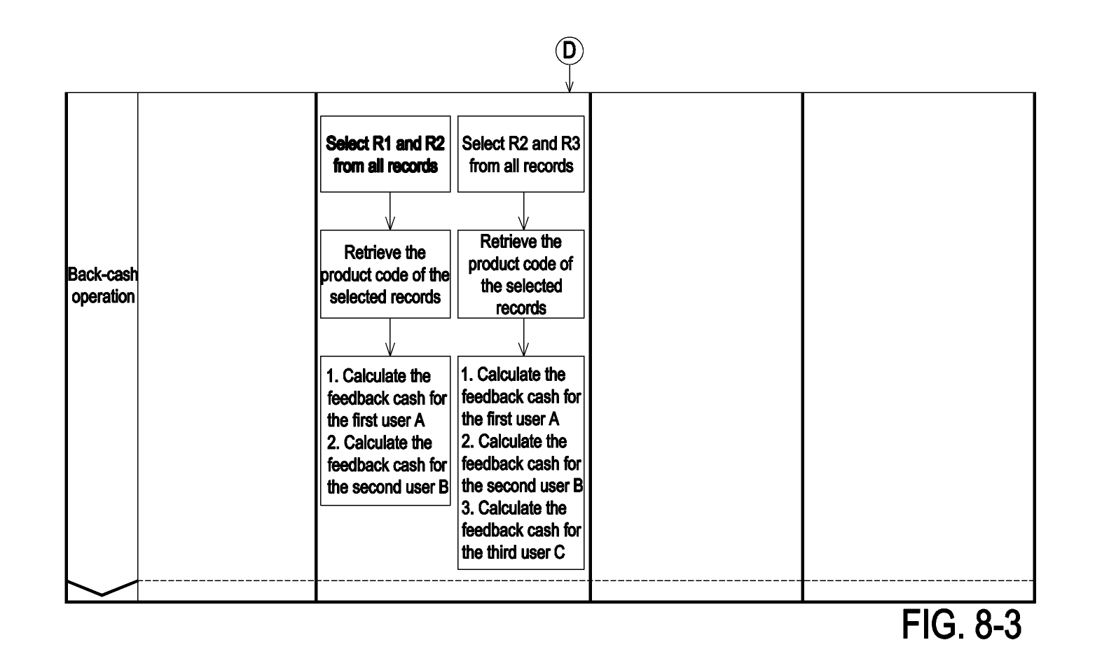

FIG. 8 is a flowchart illustrating a dynamic multi-level network marketing method according to another embodiment of the present invention. Please refer to FIGS. 1 and 8. In this embodiment, the user terminal devices 11 comprises a first user terminal device 111, a second user terminal device 112 and a third user terminal device 113, which are respectively operated by a first user A, a second user B and a third user C. The network trading platform system 10 is in communication with the first user terminal device 111 of the first user A, the second user terminal device 112 of the second user B and the third user terminal device 113 of the third user C. After the first user A accesses the network trading platform system 10 through the portal site 102 of the network trading platform system 10, the first user A may browse the commodities listed in the network trading platform system 10 and determine whether a transaction is done. Through the first user terminal device 111, the first user A may issue a transaction confirmation signal to the network trading platform system 10 to confirm that the first user A wants to purchase a first product P1 at a first price D1. In response to the transaction confirmation signal, the network trading platform system 10 automatically generates a first transaction and referral record R1 and stores the first transaction and referral record R1 in the database 103 of the network trading platform system 10. In an embodiment, the first transaction and referral record R1 at least comprises a user identification code UA, a referral record source code “N”, a level code L1, a product identification code P1, a product price D1 and a transaction time T1. The user identification code UA denotes that this transaction is implemented by the first user A. The referral record source code “N” denotes that this transaction is originally created without following any referral record source. The level code L1 denotes that the first user A is the first-level member of the dynamic multi-level network marketing structure. The product identification code P1 denotes that the product to be purchased is the first product P1. The product price D1 denotes that the product price is the first price D1. The transaction time T1 denotes that the transaction is made at the time T1.

After the transaction of the first user A has been done, the network trading platform system 10 actively issues a web page notification message to the first user terminal device 111. The web page notification message may notify the first user A of the completion of the transaction and prompt the first user A whether a referral of the first product P1 needs to be issued. The web page notification message includes the message associated with the cash-back earning from the product referral. When the first user A wants to issue a product referral message to his (or her) friends or familiar or unfamiliar friends of a social network according to the web page notification message or a fancy to the traded product, the first user A may confirm the web page notification message and select the address data of the to-be-referred persons. The to-be-referred persons may be the registered members or non-members. After a referral confirmation signal from the first user terminal device 111 is received by the network trading platform system 10, the network trading platform system 10 automatically issues a product referral message to the person(s) referred by the first user A. For example, the network trading platform system 10 automatically issues the product referral message to the second user B. In an embodiment, the network trading platform system 10 may actively issues a first product referral message to the e-mail box of the second user B. For example, the first product referral message is a web page link message including the first transaction and referral record R1.

After the first product referral message from the first user A or the network trading platform system 10 is received by the second user terminal device 112 of the second user B, the second user B may link to the network trading platform system 10 according to the first product referral message. The second user B may issue a transaction confirmation signal to the network trading platform system 10 to confirm that the second user B wants to purchase the first product P1 at a second price D2, wherein the second price D2 and the first price D1 are identical or different. In response to the transaction confirmation signal, the network trading platform system 10 automatically generates a second transaction and referral record R2 and stores the second transaction and referral record R2 in the database 103 of the network trading platform system 10. In this embodiment, the second transaction and referral record R2 at least comprises a user identification code UB, a referral record source code “R1”, a level code L2, a product identification code P1, a product price D2 and a transaction time T2. On the other hand, after the first product referral message from the first user A or the network trading platform system 10 is received by the second user terminal device 112 of the second user B, if the second user B does not link to the network trading platform system 10 according to the first product referral message, the network trading platform system 10 will not generate any transaction and referral record associated with the second user B.

After the transaction of the second user B has been done, the network trading platform system 10 actively issues a web page notification message to the second user terminal device 112. The web page notification message may notify the second user B of the completion of the transaction and prompt the second user B whether a referral of the first product P1 needs to be issued. The web page notification message includes the message associated with the cash-back earning from the product referral. When the second user B wants to issue a product referral message to his (or her) friends or familiar or unfamiliar friends of a social network according to the web page notification message or a fancy to the traded product, the second user B may confirm the web page notification message and select the address data of the to-be-referred persons. The to-be-referred persons may be the registered members or non-members. After a referral confirmation signal from the second user terminal device 112 is received by the network trading platform system 10, the network trading platform system 10 automatically issues a product referral message to the person(s) referred by the second user B. For example, the network trading platform system 10 automatically issues the product referral message to the third user C. In an embodiment, the network trading platform system 10 may actively issues a second product referral message to the e-mail box of the third user C. For example, the second product referral message is a web page link message including the second transaction and referral record R2.

After the second product referral message from the second user B or the network trading platform system 10 is received by the third user terminal device 113 of the third user C, the third user C may link to the network trading platform system 10 according to the second product referral message. The third user C may issue a transaction confirmation signal to the network trading platform system 10 to confirm that the third user C wants to purchase the first product P1 at a third price D3, wherein the first price D1, the second price D2 and the third price D3 are identical or different. In response to the transaction confirmation signal, the network trading platform system 10 automatically generates a third transaction and referral record R3 and stores the third transaction and referral record R3 in the database 103 of the network trading platform system 10. In this embodiment, the third transaction and referral record R3 at least comprises a user identification code UC, a referral record source code “R2”, a level code L3, a product identification code P1, a product price D3 and a transaction time T3. On the other hand, after the first product referral message from the second user B or the network trading platform system 10 is received by the third user terminal device 113 of the third user C, if the third user C does not link to the network trading platform system 10 according to the second product referral message, the network trading platform system 10 will not generate any transaction and referral record associated with the third user C.

The network trading platform system 10 not only implements the above network trading and active referring procedures but also automatically implements a cash-back operation. The cash-back operation automatically implemented by the network trading platform system 10 will be illustrated as follows. Firstly, the network trading platform system 10 periodically searches the data stored in the database 103. That is, the network trading platform system 10 may search the transaction and referral records in a constant time cycle. For example, according to the transaction and referral records, the first user A, the second user B and the third user C are respectively assigned as a first-level member, a second-level member, a second-level member and a third-level member by the network trading platform system 10. By the network trading platform system 10, the referral recode codes including the referral record source code “R1” and the level code “L2” are searched from the plurality of transaction and referral records, and the product price D is acquired. Then, the network trading platform system 10 will multiply the product price D and a first predetermined feedback cash percentage W1 % of the first-level member together. In such way, the feedback cash based on the product transaction and referral behavior of the first user A is obtained. That is, the feedback cash for the first user A=(D2)×W1 %, wherein W1 is a positive number. Similarly, the network trading platform system 10 will multiply the product price D and a second predetermined feedback cash percentage W2 % of the second-level member together. In such way, the feedback cash based on the product transaction and referral behavior of the second user B is obtained. That is, the feedback cash for the second user B=(D2)×W2 %, wherein W2 is a positive number.

Then, by the network trading platform system 10, the referral recode codes including the referral record source code “R2” and the level code “L3” are searched from the plurality of transaction and referral records, and the product price D is acquired. Then, the network trading platform system 10 will multiply the product price D and the first predetermined feedback cash percentage W1 % of the first-level member together. In such way, the feedback cash based on the product transaction and referral behavior of the first user A is obtained. That is, the feedback cash for the first user A=(0)×W1 %. Similarly, the network trading platform system 10 will multiply the product price D and the second predetermined feedback cash percentage W2 % of the second-level member together, and thus the feedback cash for the second user B=(D3)×W2 %. Similarly, the network trading platform system 10 will multiply the product price D and a third predetermined feedback cash percentage W2 % of the third-level member together, and thus the feedback cash for the third user C=(D3)×W3 %, wherein W1 is a positive number.

The sum of the feedback cash for the first user A=(D2)×W1 %+(0)×W1 %=(D2)×W1 %. The sum of the feedback cash for the second user B=D2×W2 %+D3×W2 %=(D2+D3)×*W2 %. The sum of the feedback cash for the third user C=(D3)×W3 %. It is noted that the descriptions of above cash-back operation are presented herein for purpose of illustration and description only. Alternatively, the cash-back operation of the present invention may be implemented according to the plurality of transaction and referral records.

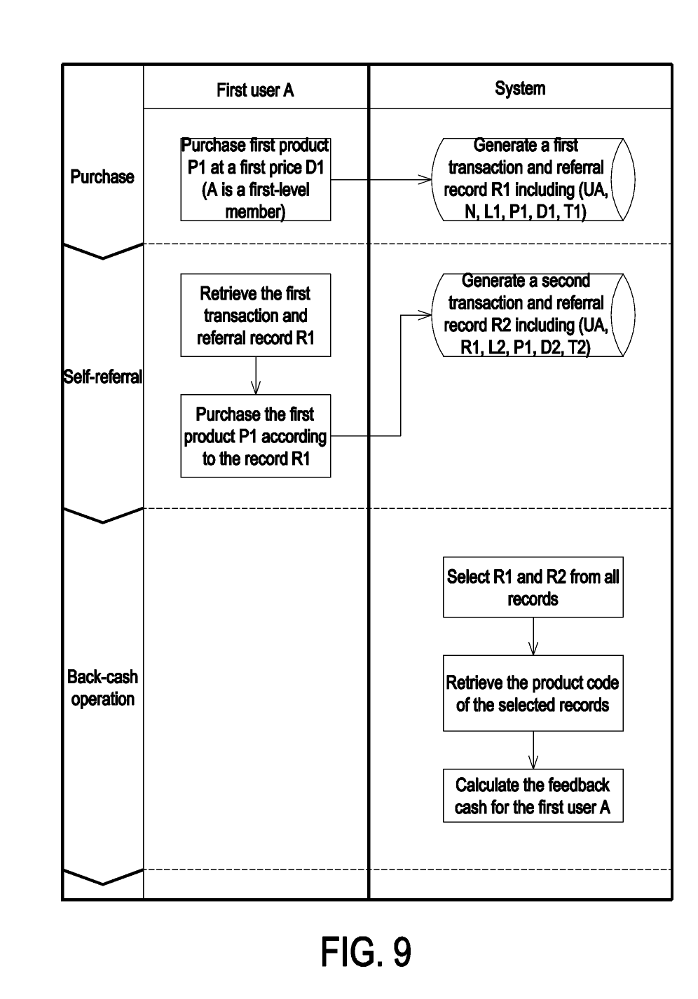

FIG. 9 is a flowchart illustrating a self-referral procedure of a dynamic multi-level network marketing method according to another embodiment of the present invention. Please refer to FIGS. 1 and 9. After the user accesses the network trading platform system 10 through a portal site 102 of the network trading platform system 10, the user may browse the commodities listed in the network trading platform system 10 and determine whether a transaction is done. For example, through the user terminal device 11, the user may issue a transaction confirmation signal to the network trading platform system 10 to confirm that the user wants to purchase a specified product P at a specified price D. In response to the transaction confirmation signal, the network trading platform system 10 automatically generates a first transaction and referral record R1 and stores the first transaction and referral record R in a database 103 of the network trading platform system 10. In this embodiment, the first transaction and referral record R1 at least comprises a user identification code UA, a referral record source code “N”, a level code L1, a product identification code P1, a product price D1 and a transaction time T1. The user identification code UA denotes that this transaction is implemented by the first user A. The referral record source code “N” denotes that this transaction is originally created without following any referral record source. The level code L1 denotes that the first user A is the first-level member of the dynamic multi-level network marketing structure. The product identification code P1 denotes that the product to be purchased is the first product P1. The product price D1 denotes that the product price is the first price D1. The transaction time T1 denotes that the transaction is made at the time T1.

After the first user A has purchased the first product P1 for a time period, if the first user A wants to purchase the first product P1 or the same-kind product, the first user A may accesses the network trading platform system 10 through the first user terminal device 111 and retrieve the first transaction and referral record R1, which is previously stored in the database 103. According to the first transaction and referral record R1, the first user A may issue a transaction confirmation signal to the network trading platform system 10 to confirm that the first user A wants to purchase another first product P1. In response to the transaction confirmation signal, the network trading platform system 10 judges that this transaction is referred according to first transaction and referral record R1 of the first user A. That is, this transaction is self-referred by the first user A. Moreover, in response to the transaction confirmation signal, the network trading platform system 10 may realize that the first user A wants to purchase the first product P1 at a second price D2, wherein the second price D2 and the first price D1 are identical or different. Meanwhile, the network trading platform system 10 automatically generates a second transaction and referral record R2 and stores the second transaction and referral record R2 in the database 103 of the network trading platform system 10. In this embodiment, the second transaction and referral record R2 at least comprises a user identification code UA a referral record source code “R1”, a level code L2, a product identification code P1, a product price D2 and a transaction time T2. In such way, the multi-level marketing relationship between the first user A and the first user A is established.

The network trading platform system 10 not only implements the above network trading and active referring procedures but also automatically implements a cash-back operation. The cash-back operation automatically implemented by the network trading platform system 10 will be illustrated as follows. Firstly, the network trading platform system 10 periodically searches the data stored in the database 103. That is, the network trading platform system 10 may search the transaction and referral records in a constant time cycle. For example, according to the transaction and referral records, the first user A corresponding to the earlier transaction and the second user B corresponding to the later transaction are respectively assigned as a first-level member and a second-level member by the network trading platform system 10. By the network trading platform system 10, the referral recode codes including the referral record source code “R1” and the level code “L2” are searched from the plurality of transaction and referral records, and the product price D is acquired. Then, the network trading platform system 10 will multiply the product price D and a first predetermined feedback cash percentage W1 % of the first-level member together. In such way, the feedback cash based on the product transaction and referral behavior of the first user A is obtained. That is, the feedback cash for the first user A=(D2)×W1 %, wherein W1 is a positive number. Similarly, the network trading platform system 10 will multiply the product price D and a second predetermined feedback cash percentage W2 % of the second-level member together. In such way, another feedback cash to be given to the first user A is obtained. That is, another feedback cash for the first user A=(D2)×W2 %, wherein W2 is a positive number. Therefore, the sum of the feedback cash for the first user A=(D2)×(W1 %+W2 %).

The present invention further provides a computer-readable recording medium. The computer-readable recording medium contains an application program for implementing the dynamic multi-level network marketing method. The dynamic multi-level network marketing method comprises steps of generating and storing a plurality of transaction and referral records according to a transaction of a specified product and a referral from a plurality of user terminal devices, and dynamically establishing a multi-level marketing relationship between the user terminal devices according to the transaction and referral records.

From the above description, the uses of the dynamic multi-level network marketing system and method of the present invention are capable of implementing the dynamic multi-level network marketing efficacy through network connection. A multi-level marketing relationship is dynamically established according to the purchasing and referring behaviors of the buyers in order to calculate and distribute the feedback cash for the buyers. In such way, the willingness of the buyers to make a transaction and recommend the product will be enhanced and the sellers can quickly introduce their products to the potential customers. Therefore, the multi-level marketing system of the present invention is able to render rapid and vigorous growth of commodity trading and membership organization. The network trading platform system is capable of dynamically establishing a multi-level marketing relationship between the buyers according to the occasional product transaction and referral behaviors. Moreover, the referred buyers can get the cash-back earning from the product referral after the online transaction behavior is done. Consequently, the willingness of the buyers to recommend the product to their friends or friends of a social network will be enhanced and the dynamic multi-level network marketing efficacy will be increased. Moreover, the dynamic multi-level network marketing system and the dynamic multi-level network marketing method of the present invention have an automatic sorting function and a self-referral function, so that the willingness to make a transaction and recommend the product will be enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-level network marketing system, comprising:
a communication network;
a plurality of user terminal devices in communication with said communication network; and
a network trading platform system in communication with said user terminal devices through said communication network for providing online commodity sale and shopping service, wherein said network trading platform system generates and stores a plurality of transaction and referral records according to a transaction of a specified product and a referral from said user terminal devices, so that a multi-level marketing relationship between said user terminal devices is dynamically established according to said transaction and referral records.

2. The multi-level network marketing system according to claim 1 further comprising one or more supply terminal devices, which are in communication with said network trading platform system through said communication network.

3. The multi-level network marketing system according to claim 2 wherein said network trading platform system comprises one or more servers, said user terminal device is a computer, a tablet personal computer or a smart phone, and said supply terminal device is a computer, a tablet personal computer or a smart phone.

4. The multi-level network marketing system according to claim 1 wherein said network trading platform system comprises a database, and said network trading platform system provides a portal site, wherein the user terminal devices are accessible to said network trading platform system through said portal site.

5. The multi-level network marketing system according to claim 4 wherein when a transaction confirmation signal is issued from a specified user terminal devices to said network trading platform system, in response to said transaction confirmation signal, a corresponding transaction and referral record is automatically generated and stored into said database by said network trading platform system, and a web page notification message is automatically issued to said specified user terminal device to prompt said specified user terminal device whether a referral of said specified product is done.

6. The multi-level network marketing system according to claim 5 wherein after a referral confirmation signal from said specified user terminal device is received by said network trading platform system, the network trading platform system automatically issues a product referral message to one or more user terminal devices that are referred by said specified user terminal device.

7. The multi-level network marketing system according to claim 6 wherein said product referral message is a web page link message including said transaction and referral record.

8. The multi-level network marketing system according to claim 7 wherein when any referred user terminal device links to said network trading platform system according to said product referral message and issues a transaction confirmation signal, another transaction and referral record is automatically generated and stored into said database by said network trading platform system.

9. The multi-level network marketing system according to claim 8 wherein said network trading platform system implements a cash-back operation according to said plurality of transaction and referral records.

10. The multi-level network marketing system according to claim 1 wherein each of said transaction and referral records at least comprises a user identification code, a referral record source code, a level code, a product identification code, a product price and a transaction time.

11. The multi-level network marketing system according to claim 1 wherein said network trading platform system further performs a sorting procedure.

12. A multi-level network marketing method, comprising steps of:
providing a communication network, a plurality of user terminal devices and a network trading platform system, wherein said user terminal devices are in communication with said communication network, and said network trading platform system in communication with said user terminal devices through said communication network for providing online commodity sale and shopping service; and
generating and storing a plurality of transaction and referral records according to a transaction of a specified product and a referral from said user terminal devices, so that a multi-level marketing relationship between said user terminal devices is dynamically established according to said transaction and referral records.

13. The multi-level network marketing method according to claim 12 wherein when a transaction confirmation signal is issued from a specified user terminal devices to said network trading platform system, in response to said transaction confirmation signal, a corresponding transaction and referral record is automatically generated and stored into said database by said network trading platform system, and a web page notification message is automatically issued to said specified user terminal device to prompt said specified user terminal device whether a referral of said specified product is done.

14. The multi-level network marketing method according to claim 13 wherein after a referral confirmation signal from said specified user terminal device is received by said network trading platform system, the network trading platform system automatically issues a product referral message to one or more user terminal devices that are referred by said specified user terminal device.

15. The multi-level network marketing method according to claim 14 wherein said product referral message is a web page link message including said transaction and referral record.

16. The multi-level network marketing method according to claim 15 wherein when any referred user terminal device links to said network trading platform system according to said product referral message and issues a transaction confirmation signal, another transaction and referral record is automatically generated and stored into said database by said network trading platform system.

17. The multi-level network marketing method according to claim 16 wherein said network trading platform system implements a cash-back operation according to said plurality of transaction and referral records.

18. The multi-level network marketing method according to claim 12 further comprising a step of performing a sorting procedure.

19. A computer-readable recording medium containing an application program for implementing the multi-level network marketing method, said multi-level network marketing method comprising steps of generating and storing a plurality of transaction and referral records according to a transaction of a specified product and a referral from a plurality of user terminal devices, and dynamically establishing a multi-level marketing relationship between said user terminal devices according to said transaction and referral records.
